(19) United States
(12) Patent Application Publication
(10) Pub. No.: US 2011/0246605 A1
(43) Pub. Date: Oct. 6, 2011

(54) Method for Handling Information Delivery in Personal Network and Related Communication Device

(76) Inventors: Ju-Ting Yang, Taoyuan County (TW); Ho-Sung Chien, Taoyuan County (TW); Yin-Yeh Tseng, Taoyuan County (TW)

(21) Appl. No.: 13/076,455

(22) Filed: Mar. 31, 2011

Related U.S. Application Data
(60) Provisional application No. 61/319,278, filed on Mar. 31, 2010.

(51) Int. Cl. G06F 15/16

(52) U.S. Cl. 709/217

(57) ABSTRACT

A server is disclosed. A method of handling information delivery for the server comprises sending information to at least one personal network entity (PNE) of a first group, wherein the first group comprises a plurality of PNEs. Besides, a method of handling information delivery for the gateway which transfers signals between a server and a plurality of personal network entities (PNEs) is also disclosed. The method comprises maintaining a group list and one corresponding group ID, wherein the group list indicates all personal network entities (PNEs) in one group and the PNEs share the group ID.

### CROSS REFERENCE TO RELATED APPLICATIONS

This application claims the benefit of U.S. Provisional Application No. 61/319,278, filed on Mar. 31, 2010 and entitled “Method for Instant Information Delivery in Extended Personal Area Network”, the contents of which are incorporated herein.

### BACKGROUND OF THE INVENTION

1. Field of the Invention

The application relates to a method used in a personal network and related communication device, and more particularly, to a method for handling information delivery in a personal network and related communication device.

2. Description of the Prior Art

Nowadays users are increasingly connecting their devices to short-range Personal Networks (PNs) such as home networks, in-car networks and body area networks. Connecting these PNs to other networks can greatly extend the accessibility of the devices, or personal network elements (PNE(s)), in the PNs, enabling a number of compelling Services, including access by PNE(s) to services outside the PN (e.g. a Bluetooth-connected Personal Media Player (PMP) uses your cell phone's WAN connection to receive a video streamed from the Internet).

Open Mobile Alliance (OMA) is the focal point for the development of mobile service enabler specifications, which support the creation of interoperable end-to-end mobile services. OMA drives service enabler architectures and open enabler interfaces that are independent of the underlying wireless networks and platforms. OMA creates interoperable mobile data service enablers that work across devices, service providers, operators, networks, and geography. Toward that end, OMA will develop test specifications, encourage third party tool development, and conduct test activities that allow vendors to test their implementations.

The goal of OMA Converged Personal Network Services (CPNS) enabler is to provide application-layer support for ubiquitous access to services in a converged network, which is a collection of individual networks that are interconnected by means of PN Gateway (PN-GW) devices (in the example above, the cell phone assumes the role of a PN-GW that converges the Bluetooth and cellular networks to enable video to be streamed to the PMP from a network server). In the basic architecture of CPNS, three main CPNS enabler entities are the CPNS server, the PN-GW, and the PNE(s). The CPNS server is an entity of CPNS enabler that replies to requests from the PN-GW and ensures that the appropriate application is selected and appropriate content is provided to the PNE(s). The PN-GW serves as an intermediary entity between the PNE (s) and other networks that forwards the requests from the PNE(s) to the other networks and the other way around. The PN-GW can be a mobile phone, or an IP-enabled set-top box. The PNE(s) are PN entities that are connected to the PN-GW and between each other and are used for rendering the content received from the PN-GW or from each other. The PNE can be a mobile phone, a PC, a music player, car navigation system or an IP-enabled set-top box. A CPNS user may own a number of devices such as a mobile phone, a PC, a music player, and an IP-enabled set-top box. These devices construct an “Extended Personal Area Network” which is mentioned in

### OMA-RD-CPNS-V1_{—}0-20091117-C.

### SUMMARY OF THE INVENTION

A server is provided for handling information delivery.

A server is disclosed. The server comprises a memory unit and a processor. The memory unit is used for storing a program code corresponding to a process. The processor is coupled to the memory unit and used for processing the program code to execute the process. The process comprises establishing a first group according to a first request and sending information to at least one accessible personal network entities (PNEs) of the first group, wherein the first group comprises a plurality of PNEs.

A method of handling information delivery for a server is disclosed. The method comprises establishing a first group according to a first request and sending information to at least one accessible personal network entities (PNEs) of the first group, wherein the first group comprises a plurality of PNEs.

A gateway for transferring signals between a server and a plurality of personal network entities (PNEs) is disclosed. The gateway comprises a memory unit and a processor. The memory unit is used for storing a program code corresponding to a process. The processor is coupled to the memory unit and used for processing the program code to execute the process. The process comprises maintaining a group list and one corresponding group ID, wherein the group list indicates all personal network entities (PNEs) in one group and the PNEs share the group ID.

A method of handling information delivery for a gateway is disclosed. The gateway is used for transferring signals between a server and a plurality of personal network entities (PNEs). The method comprises maintaining a group list and one corresponding group ID, wherein the group list indicates all personal network entities (PNEs) in one group and the PNEs share the group ID.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a schematic diagram of an exemplary personal network.

FIG. 2 is a schematic diagram of an exemplary communication device.

FIG. 3 is a flow chart of an exemplary process.

FIG. 4 is a flow chart of an exemplary process.

FIG. 5 is a schematic diagram of another exemplary personal network.

FIG. 6 is a schematic diagram of another exemplary personal network.

FIG. 7 is a schematic diagram of another exemplary personal network.

### DETAILED DESCRIPTION

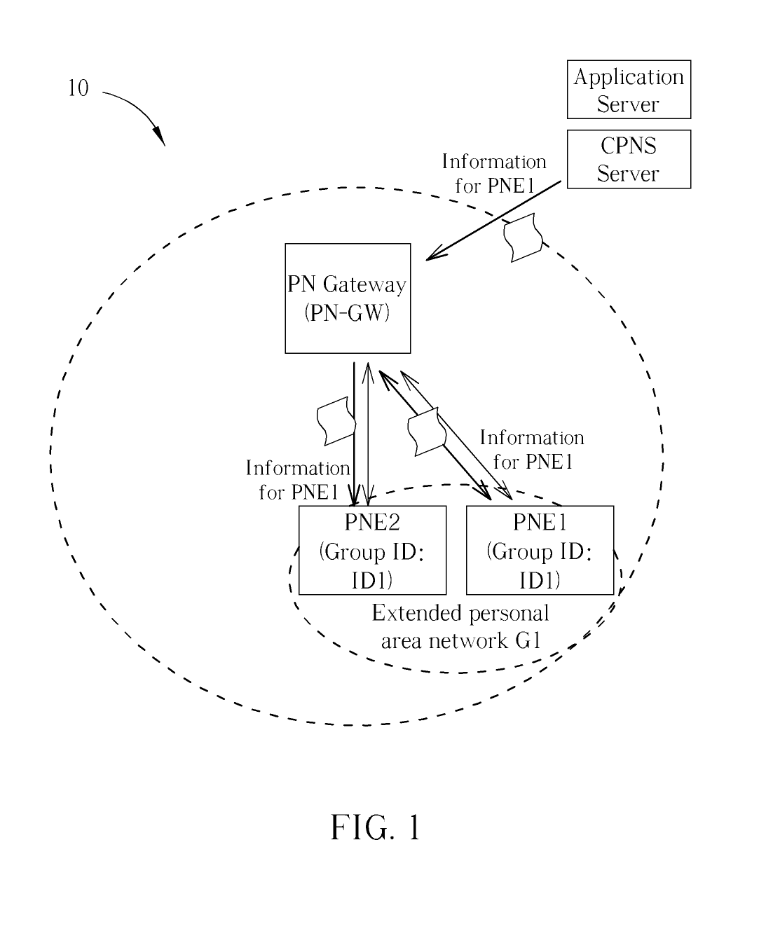

Please refer to FIG. 1, which is a schematic diagram of an exemplary personal network 10. The personal network 10 comprises an application server, a converged personal network services (CPNS) server, a personal network gateway (PN-GW) and personal network entities (PNEs) PNE1, and PNE2 (for simplicity, only two PNEs are shown in FIG. 1, but not limited herein). The CPNS server replies to requests from the PN-GW and ensures that the appropriate application is selected and appropriate content is provided to the PNE1 and PNE2. The PN-GW serves as an intermediary entity between the PNE1 and PNE2 and other networks that forwards the requests from the PNE1 and PNE2 to the other networks and the other way around. Preferably, the PN-GW may be referred to as a mobile device, or an IP-enabled set-top box. The PNE1 and PNE2 share a group identity ID1. The group identity ID1 is assigned by the server (e.g. PNID) or based on an account or a password of each PNE. The group identity ID1 is identified by the PN-GW. The PNE1 and PNE2 are connected to the PN-GW and between each other and are used for rendering the content received from the PN-GW or from each other. The PNE1 and PNE2 may be referred to as a mobile device, a PC, a music player, car navigation system or an IP-enabled set-top box. In other words, a mobile device functions as the PNE or the PN-GW, depending on user's demand.

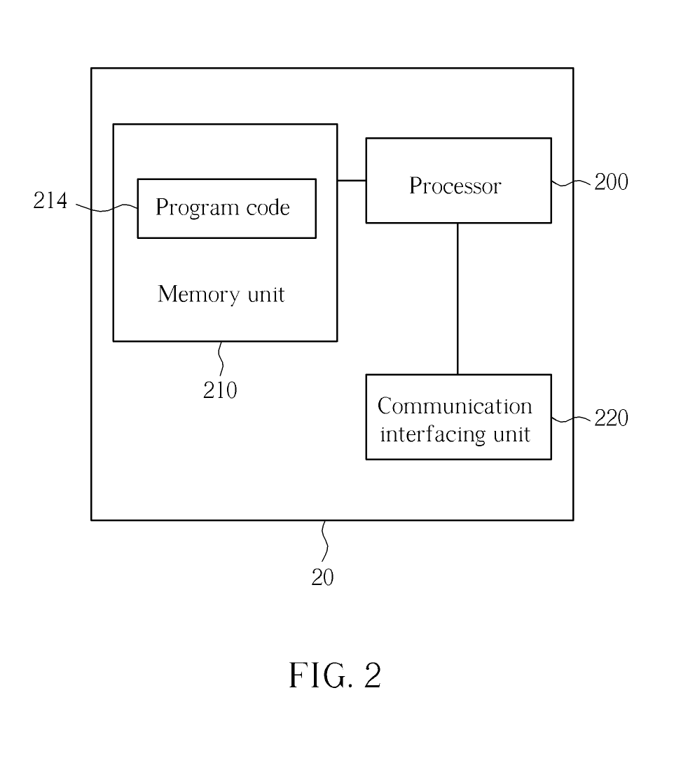

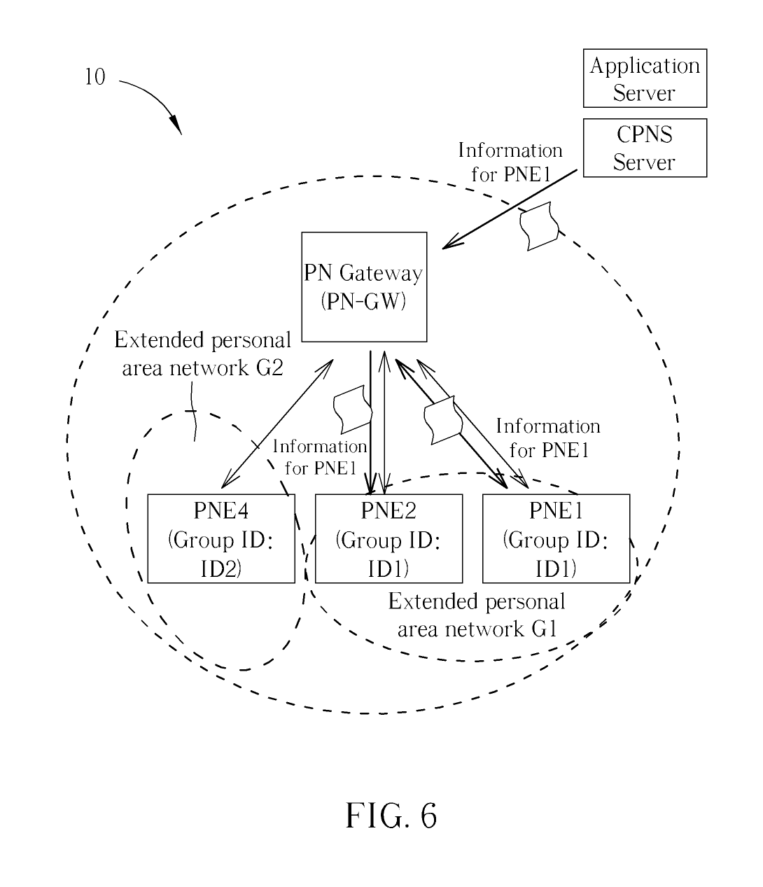

FIG. 2 is a schematic diagram of an exemplary communication device 20. The communication device 20 can be the server, the PN-GW, PNE1, PNE2, PNE3 or PNE4 shown in FIG. 6 and may include a processor 200 such as a microprocessor or ASIC, a memory unit 210, and a communication interfacing unit 220. The memory unit 210 may be any data storage device that can store program code 214, for access by the processor 200. Examples of the memory unit 210 include but are not limited to a subscriber identity module (SIM), read-only memory (ROM), random-access memory (RAM), CD-ROMs, magnetic tapes, hard disks, and optical data storage devices. The communication interfacing unit 220 is preferably a radio transceiver for wirelessly communicating with the network according to processing results of the processor 200.

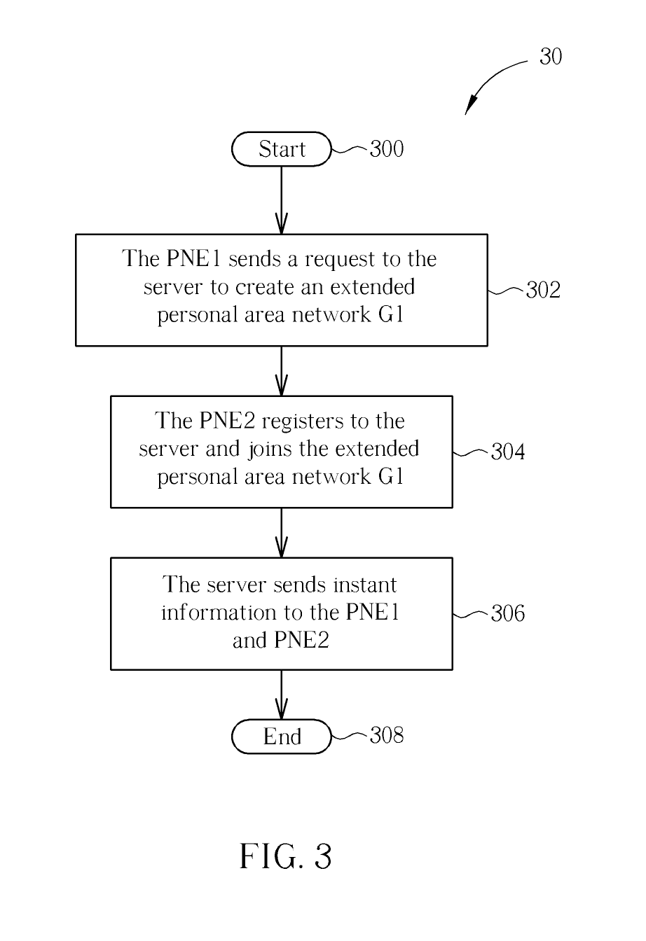

Please refer to FIG. 3, which is a flow chart of an exemplary process 30. The process 30 is used for handling information delivery for the CPNS server shown in FIG. 1. The process 30 can be compiled into the program code 214 and include the following steps:

Step 300: Start.

Step 302: The PNE1 sends a request R1 to the server to create an extended personal area network G1.

Step 304: The PNE2 registers to the server and joins the extended personal area network G1.

Step 306: The CPNS server sends instant information to the PNE1 and PNE2.

Step 308: End.

According to the process 30, the PNE1 first sends the request R1 to the CPNS server to create the extended personal area network G1. The request R1 is a request sent from a PNE to create the extended personal area network G1. All PNEs within the extended personal network G1 share the same unique group identity. The PNE2 registers to the server and join the extended personal area network G1. Since the PNE1 and PNE2 belong to the extended personal area network G1, the PNE1 and PNE2 share the same group identity ID1. When the server has the information for delivery, the server sends the information to both of the PNE1 and PNE2. In other words, the server sends the information to the all PNEs in the same extended personal area network, and it doesn't matter whether one PNE is accessible or not.

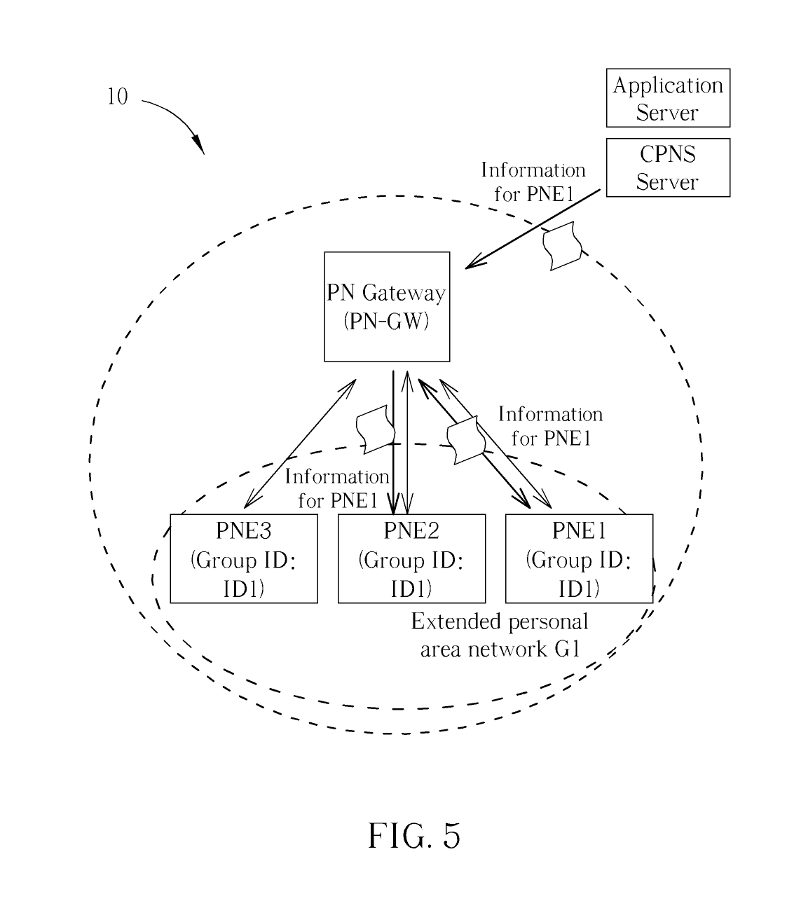

Please refer to FIG. 5, which is a schematic diagram of another exemplary personal network 10. In FIG. 5, the personal network 10 includes a PNE3, which has the same group identity ID1 and belongs to the same extended personal area network G1. In this situation, the CPNS server sends the information to the PNE1 and the PNE2 when the CPNS server receives the request R1 from the PNE1 and is not able to access to the PNE3.

Please refer to FIG. 6, which is a schematic diagram of another exemplary personal network 10. The extended personal area network G2 includes a PNE4, which has the group identity ID2. In this situation, the PN-GW maintains a group list of extended personal area networks (e.g. G1 and G2) and one or more group identities. Each of the one or more group identity (e.g. ID1 and ID2) corresponds to a group. When the PNE2 registers to the server, the PNE2 chooses an extended personal area network of interest (e.g. G1 or G2) to join. If the PNE2 chooses the extended personal area network G1, the PNE2 shares the same group identity ID1 with the PNE1. The CPNS server receives a request R2 from the extended personal area network G2 for information delivery. The request R2 is a request sent from the extended personal area network G2 to deliver information to the PNEs. However, the PNE1 is out of service and the CPNS server is not able to access to the PNE1. At this moment, the CPNS can send the information to the PNE2 instead.

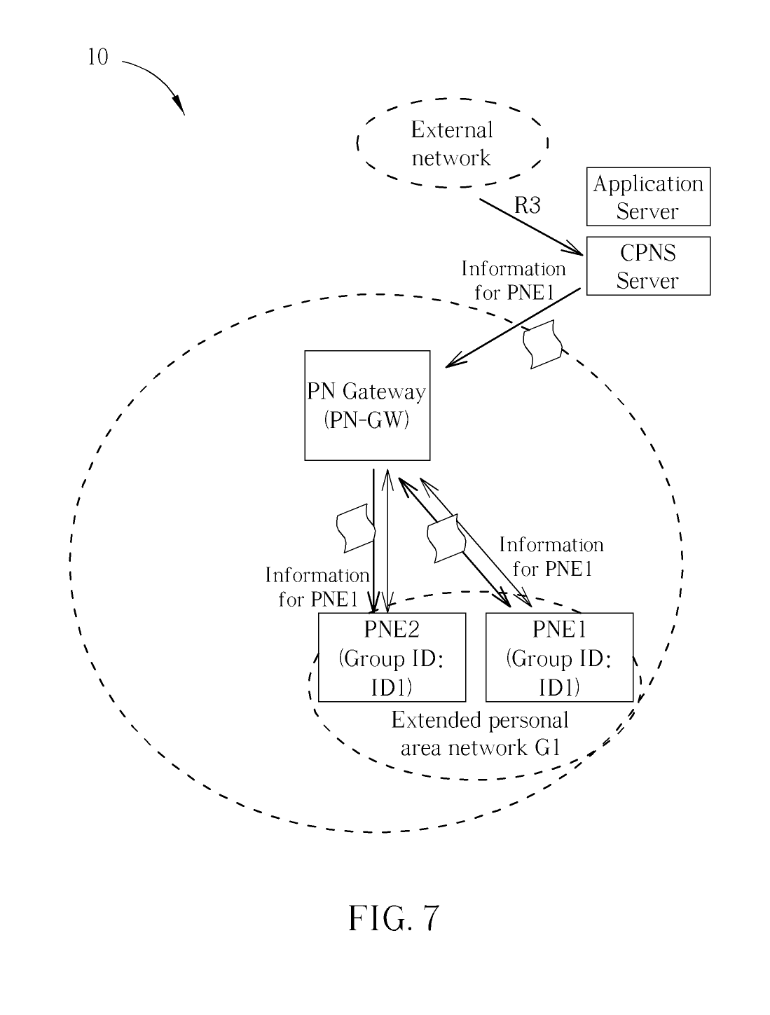

Please refer to FIG. 7, which is a schematic diagram of another exemplary personal network 10. In FIG. 7, the CPNS server connects to an external network. The CPNS server receives a request R3 from the external network for information delivery. The request R3 is a request sent from the external network to deliver information to the PNEs. The CPNS can send the information to the PNE2 when the CPNS server is not able to access to the PNE1.

According to aforementioned examples, the CPNS receives a request from the PNE1, the extended personal area network G2 or the external network for information delivery. When the CPNS user can not get access to one of its PNE inside the extended personal area network (e.g. the laptop), any information from the CPNS server intended to send to this user can then be notified and delivered immediately to all PNEs inside the extended personal area network (e.g. the mobile phone, the PMP or the car navigation system). And, it doesn't matter whether one PNE is accessible or not.

In another example, the PNE1 (e.g. PMP or mobile phone) sends the request R1 to the CPNS server for downloanding the latest information (e.g. MP3 or maps). However, the application server is temporarily unavailable for the service. The CPNS user might switch off this PNE. With this information delivery mechanism, once the corresponding application server is ready, the CPNS server informs at least one PNE inside the extended personal area network (PNE1 and/or PNE2). If the application server is ready but the PNE1 is still inaccessible, the CPNS server sends information to the PNE2. And it doesn't matter whether one PNE is accessible or not.

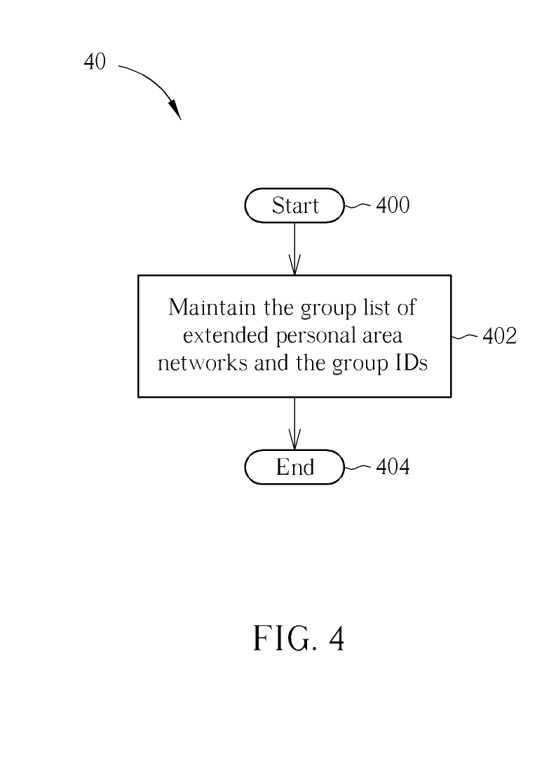

Please refer to FIG. 4, which is a flow chart of an exemplary process 40. The process 40 is used for handling information delivery for the PN-GW shown in FIG. 1. The process 40 can be compiled into the program code 214 and include the following steps:

Step 400: Start.

Step 402: Maintain the group list of extended personal area networks and the group IDs.

Step 404: End.

According to the process 40, the PN-GW maintains the group list of the extended personal area networks (e.g. G1 and G2) and the group IDs (ID1 and ID2). The detailed descriptions of the PN-GW can be found above, and thus is omitted herein.

Please note that the abovementioned steps including suggested steps can be realized by means that could be hardware, firmware known as a combination of a hardware device and computer instructions and data that reside as read-only software on the hardware device, or an electronic system. Examples of hardware can include analog, digital and mixed circuits known as microcircuit, microchip, or silicon chip. Examples of the electronic system can include system on chip (SOC), system in package (Sip), computer on module (COM), and the communication device 20 in which the processor 200 processes the program code 214 related to the abovementioned processes and the processed results can handle information delivery in the personal network 10.

To sum up, a CPNS user can create an extended personal area network in which all of the devices in share the same group identity. When any information is issued from server to one of PNEs inside the extended personal area network, this information will be shared and delivered to all PNEs inside the extended personal area network sharing the same group identity. The present embodiment utilizes the information which might be important and urgent efficiently and instantly, especially benefits while any PNE inside the extended personal area network is inaccessible or while application server is not yet ready to provide requested service for the PNEs. And it doesn't matter whether one PNE is accessible or not.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A server comprising:
a memory unit for storing a program code corresponding to a process; and
a processor coupled to the memory unit, for processing the program code to execute the process;
wherein the process comprises:
sending information to at least one personal network entity (PNE) of a first group, wherein the first group comprises a plurality of PNEs.

2. The server of claim 1, wherein the first group comprises a first PNE and a second PNE and the process further comprises sending the information to the first PNE and the second PNE when the server receives a request from a second group.

3. The server of claim 1, wherein the first group comprises a first PNE and a second PNE and the process further comprises connecting to an external network and sending the information to the first PNE and the second PNE when the server receives a request from the external network.

4. The server of claim 1, wherein the first group comprises a first PNE and a second PNE and the process further comprises sending the information to at least one of the first PNE and the second PNE before the server gets ready.

5. The server of claim 4, wherein the process further comprises sending the information to the first PNE and the second PNE when the server gets ready.

6. The server of claim 1, wherein the process further comprises assigning the same group identity (ID) to all PNEs of the first group.

7. A method of handling information delivery for a server, the method comprising:
sending information to at least one accessible personal network entity (PNE) of a first group, wherein the first group comprises a plurality of PNEs.

8. The method of claim 7 further comprising:
sending the information to a first PNE and a second PNE when the server receives a request from the second group;
wherein the first group comprises the first PNE and the second PNE.

9. The method of claim 7 further comprising:
connecting to an external network; and
sending the information to at least one of a first PNE and a second PNE when the server receives a request from the external network;
wherein the first group comprises the first PNE and the second PNE.

10. The method of claim 7 further comprising sending the information to a first PNE and a second PNE before the server gets ready; wherein the first group comprises the first PNE and the second PNE.

11. The method of claim 10 further comprising sending the information to the first PNE and the second PNE when the server gets ready.

12. The method of claim 7 further comprising assigning the same group identity (ID) to all PNEs of the first group.

13. A gateway for transferring signals between a server and a plurality of personal network entities (PNEs), the gateway comprising:
a memory unit for storing a program code corresponding to a process; and
a processor coupled to the memory unit, for processing the program code to execute the process;
wherein the process comprises:
maintaining a group list and one corresponding group ID, wherein the group list indicates all personal network entities (PNEs) in one group and the PNEs share the group ID.

14. The gateway of claim 13, wherein the gateway is a mobile phone.

15. A method of handling information delivery for a gateway, the gateway transfers signals between a server and a plurality of personal network entities (PNEs), the method comprising:
maintaining a group list and one corresponding group ID, wherein the group list indicates all personal network entities (PNEs) in one group and the PNEs share the group ID.

16. The method of claim 15, wherein the gateway is a mobile phone.
